(19) United States
(12) Patent Application Publication
(10) Pub. No.: US 2026/0256264 A1
(43) Pub. Date: Sep. 3, 2026

(54) MASSAGING BALM APPLICATOR

(71) Applicant: CHATTEM INC., Morristown, NJ (US)

(72) Inventors: Heidi GRAHAM, Charlottesville, VA (US); David SHARP, Hixon, TN (US); Congling ZHANG, Apison, TN (US); Brian RUSSELL, Lansdale, PA (US)

(21) Appl. No.: 19/489,465

(22) PCT Filed: Jun. 2, 2023
(86) PCT No.: PCT/US2023/067834

§ 371 Date: Dec. 2, 2025

(51) Int. Cl. A45D 40/16; A61H 7/00

(52) U.S. Cl. CPC A45D 40/16; A61H 7/003; A45D 2200/05; A61H 2201/0153; A61H 2201/105; A61H 2201/1635

(57) ABSTRACT

An applicator includes a housing and a retainer. The housing includes a handle unit and a cover. The handle unit includes a handle and an adapter. The cover includes a clasp to releasably secure the adapter to the cover. The retainer is configured to secure a substance thereto. The retainer includes a fastener disposed on a first rim of the retainer. The fastener is to secure the first rim of the retainer to the adapter.

### FIELD OF THE INVENTION

The present invention relates to an applicator and, more particularly, to a band-held applicator for applying a medicament, cream, lotion, and the like to a skin surface.

### BACKGROUND OF THE INVENTION

Conventional applicators for substances such as medicaments, creams, lotions, and the like are produced in several distinct categories and are generally based on the form of the substance. For example, liquid that is applied to the skin may be dispensed from a dropper or roller-ball applicator. Creams are typically dispensed from a tube or jar. Solids that are applied to the skin are typically dispensed from an applicator with a piston-like platform that is advanced via a screw shaft. However, the screw shaft mechanism and platform are relatively expensive to produce and assemble and they take up a significant portion of the internal volume of the applicator. These factors increase the cost and decrease the volume of substance for a given sized applicator.

Accordingly, it is desirable to provide an applicator for applying a solid or semi-solid substance that can offer improved performance or efficiency without the undesirable costs and wasted volume of conventional applicators.

### SUMMARY OF THE INVENTION

The foregoing needs are met, at least in part, by the present invention where, in one embodiment an applicator is disclosed.

An embodiment of the present invention provides an applicator for a substance. The applicator includes a housing and a retainer. The housing includes a handle unit and a cover. The handle unit includes a handle and an adapter. The cover includes a clasp to releasably secure the adapter to the cover. The retainer is configured to secure a substance thereto. The retainer includes a fastener disposed on a first rim of the retainer. The fastener is to secure the first rim of the retainer to the adapter.

Another embodiment relates to a formulation of the substance for the applicator. The formulation includes menthol, camphor, and a plurality of waxes and oils configured to secure the substance in the retainer.

Yet another embodiment relates to an applicator having the substance disposed therein.

Yet another embodiment relates to an applicator having the substance disposed therein. The substance may include an active pharmaceutical ingredient (API) or a formulation containing such an API. In certain embodiments, the formulation for the substance includes menthol, camphor, and a plurality of waxes and oils configured to secure the substance to the grid in the retainer.

Yet another embodiment relates to a method of making the applicator with the substance. The method includes: assembling a mold assembly by nesting the forming cup into the cover and securing the retainer to the cover with the clasp; filling the mold assembly with the substance in liquid form so that the substance covers the grid of the retainer; solidifying the substance; and pressing the filled mold assembly into the adapter to urge the fastener to fasten.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The foregoing summary, as well as the following detailed description of the invention, will be better understood when read in conjunction with the appended figure. For the purpose of illustrating the invention, the figure demonstrates embodiments of the present invention. It should be understood, however, that the invention is not limited to the precise arrangements, examples, and instrumentalities shown.

FIG. 1 is a front view of an applicator according to an embodiment of the present invention.

FIG. 2 is a front view of the applicator depicted in FIG. 1 with a cover removed to expose a substance for application on a patient.

FIG. 3 is a cross-sectional view 3-3 of the applicator of FIG. 1.

FIG. 4 is an orthogonal view of a molding assembly having a retainer, a forming cup, and the cover for the applicator of FIG. 1.

FIG. 5 is detail of a snap-lock fastener to connect the retainer to an adapter for the applicator of FIG. 1.

FIG. 6 is a flow diagram of a method for manufacturing the applicator of FIG. 1.

### DETAILED DESCRIPTION

The terms “drug” or “medicament” are used synonymously herein and describe a pharmaceutical formulation containing one or more active pharmaceutical ingredients or pharmaceutically acceptable salts or solvates thereof, and optionally a pharmaceutically acceptable carrier. An active pharmaceutical ingredient (“API”), in the broadest terms, is a chemical structure that has a biological effect on humans or animals. In pharmacology, a drug or medicament is used in the treatment, cure, prevention, or diagnosis of disease or used to otherwise enhance physical or mental well-being. A drug or medicament may be used for a limited duration, or on a regular basis for chronic disorders.

As described below, a drug or medicament can include at least one API, or combinations thereof, in diverse types of formulations, for the treatment of one or more conditions or diseases. Mixtures of one or more drugs are also contemplated. Pharmaceutically acceptable salts of any API described herein are also contemplated for use in a drug or medicament in a drug delivery device. Pharmaceutically acceptable salts are for example acid addition salts and basic salts. Those of skill in the art will understand that modifications (additions and/or removals) of various components of the APIs, formulations, apparatuses, methods, systems, and embodiments described herein may be made without departing from the full scope and spirit of the present invention, which encompass such modifications and any and all equivalents thereof.

The drug or medicament may be contained in a primary package or “drug container” adapted for use with a drug delivery device. The drug container may be, e.g., a cartridge, syringe, reservoir, or other solid or flexible vessel configured to provide a suitable chamber for storage (e.g., short- or long-term storage) of one or more drugs. For example, in some instances, the chamber may be designed to store a drug for at least one day (e.g., 1 to at least 30 days). In some instances, the chamber may be designed to store a drug for about 1 month to about 2 years. Storage may occur at room temperature (e.g., about 20° C.), or refrigerated temperatures (e.g., from about −4° C. to about 4° C.). In some instances, the drug container may be or may include a dual-chamber cartridge configured to store two or more components of the pharmaceutical formulation to-be-administered (e.g., an API and a diluent, or two different drugs) separately, one in each chamber. In such instances, the two chambers of the dual-chamber cartridge may be configured to allow mixing between the two or more components prior to and/or during dispensing into the human or animal body. For example, the two chambers may be configured such that they are in fluid communication with each other (e.g., by way of a conduit between the two chambers) and allow mixing of the two components when desired by a user prior to dispensing. Alternatively, or in addition, the two chambers may be configured to allow mixing as the components are being dispensed into the human or animal body.

In general, embodiments of an applicator described herein are suitable for use with any suitable substance such as medicaments (e.g., APIs), lotions, creams, and the like applied to a patient. For example, as described herein, advantages of the applicator include: providing an applicator that is easy and convenient to hold and administer the substance; reducing the cost and assembly time of the applicator; facilitating messaging the substance onto a skin of patient; and facilitating application of the substance on selected areas of the patient while reducing substance on the hands. These and other advantages are described herein.

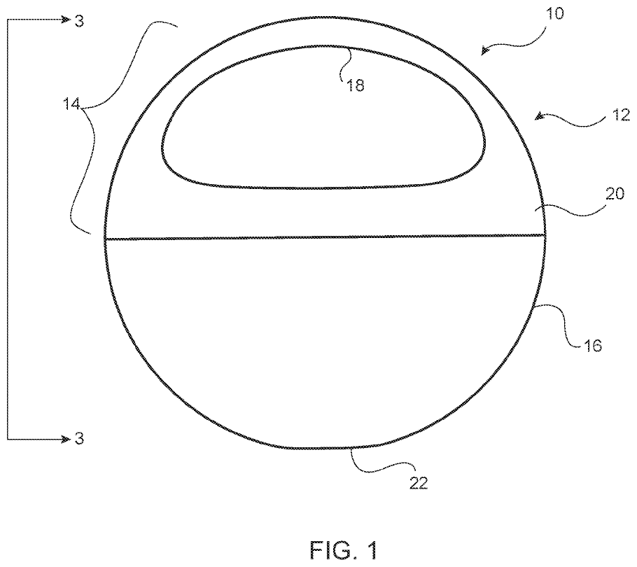

FIG. 1 is a front view of an applicator 10 according to an embodiment of the present invention. As shown in FIG. 1, the applicator 10 includes a housing 12. The housing 12 includes a handle unit 14 and a cover 16. The handle unit 14 includes a handle 18 and an adapter 20. When assembled as shown in FIG. 1, the handle 14 provides a gripping device for a patient or user to hold the applicator 10. The adapter 20 provides a transition from the handle 18 to the cover 16. In this regard, the cover 16 may be any suitable size and/or shape and the adapter 20 is configured in a corresponding manner to engage with the cover 16 to form at least a partial seal for the contents therein. Also shown in FIG. 1, the cover 16 includes a base 22 to provide a flat bearing surface upon which the applicator 10 can rest on a flat surface such as a table or shelf. In other examples, the base 22 may be larger or smaller relative to the cover 16 and/or may include legs or feet to facilitate improved stability.

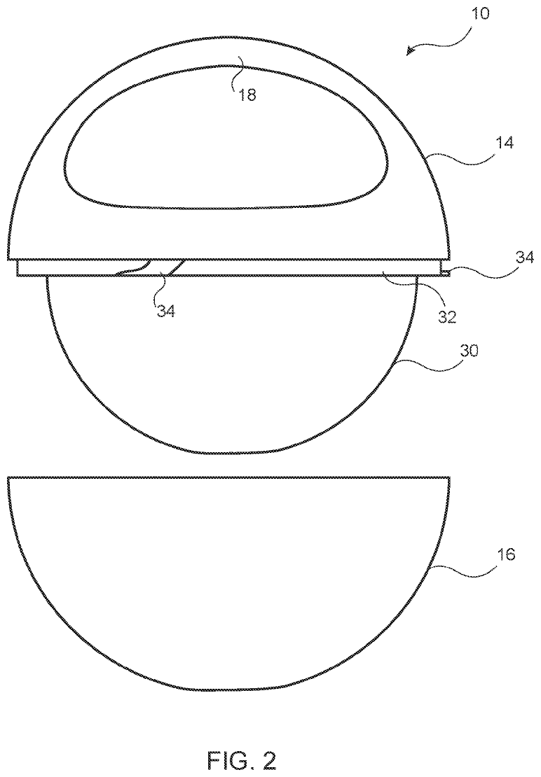

FIG. 2 is a front view of the applicator 10 depicted in FIG. 1 with the cover 16 removed to expose a substance 30 for application on a patient. The substance 30 may include any suitable medicament, lotion, cream, or the like. As shown in FIG. 2, removing the cover 16 exposes the substance 30 that is affixed to the handle 18. More particularly and as described herein, a retainer 32 is cast into the substance 30 to securely affix the substance 30 to the retainer 32 upon solidification of the substance 30. The retainer 32 is fastened to the adapter 20 so that the handle 18 is secured to the substance 30. Also shown in FIG. 2, the retainer 32 includes a clasp 34 or other such device with interlocking parts to releasably couple with a corresponding feature on the cover 16. As described herein, the retainer 32 is securely fastened to the adapter 20, and thus, the handle 18. In this manner, the handle 18 and the cover 16 are releasably coupled.

An advantage of the applicator 10 shown herein is that the handle 18 provides a secure grip and the adapter 20 provides a barrier or shield to reduce application of the substance 30 from contacting the hands of the user holding the handle 18. This can be advantageous if the substance 30 is lubricious or might otherwise affect gripping the handle 18. Another advantage is that all of the substance 30 is available for use without the need to advance additional substance out of a screw and piston mechanism, for example. Yet another advantage is that the user can see all of the remaining substance 30. As such, the user is less likely to surprisingly run out of the substance 30.

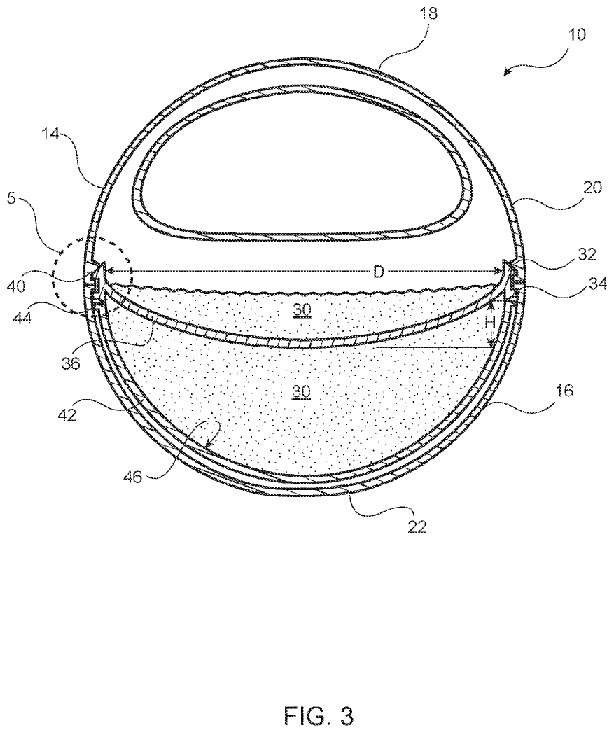

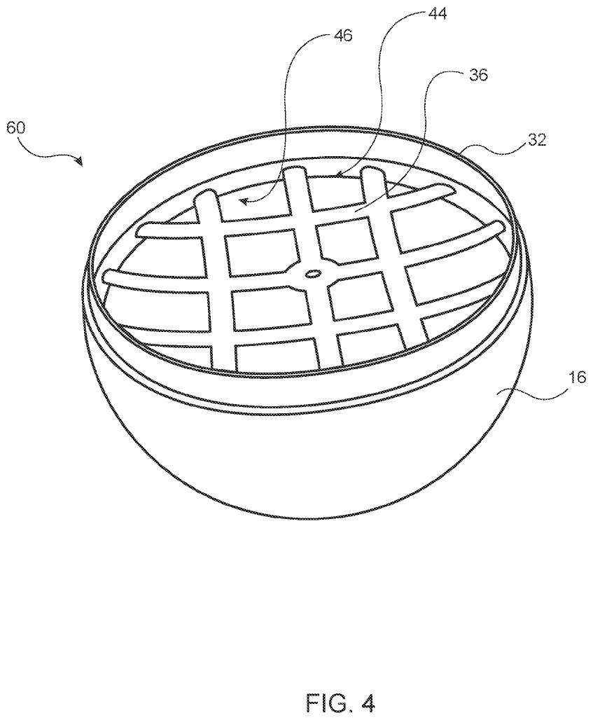

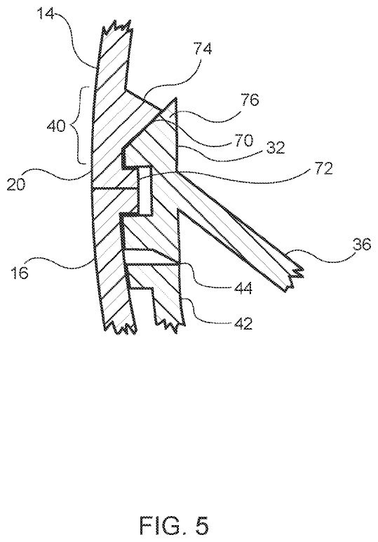

FIG. 3 is a cross-sectional view 3-3 of the applicator 10 of FIG. 1. As shown in FIG. 3, the applicator 10 is in a closed or covered conformation with the cover 16 coupled to the handle unit 14 via the retainer 32. Also shown in FIG. 3, the retainer 32 is fastened to the adapter 20 via a snap-lock 40 which is shown in greater detail in FIG. 5. As shown in FIGS. 3 and 4, the retainer 32 includes a grid 36 that is cast into the substance 30 so that the grid 36 is encased in the substance 30. In this manner, the substance 30 is secured to the adapter 20 and thus, secured to the handle 18. In various examples, the grid 36 may include any shape or conformation suitable for securing the substance 30 thereto while reducing a loss of integrity of the substance 30. In this regard, the concave shape of the grid 36 shown in FIG. 3 and the open structure of the grid 36 shown in FIG. 4 is configured to facilitate a secure attachment between the grid 36 and the substance 30 while reducing loss of integrity of the substance 30. However, the shape of the grid need not be concave and may be convex or wavy or irregular or having some portion that extends into or out from a plane of the retainer 32. The portion of the grid 36 extending above or below the retainer 32 may be described by a height H the grid 36 extends into the substance 30 in relation to a diameter D of the substance 30. Generally, suitable extensions of the grid 36 include a height to diameter ratio of about 5% to about 15%. Other suitable extensions of the grid 36 include a height to diameter ratio of about 7% to about 14%. More particularly, the suitable extensions of the grid 36 include a height to diameter ratio of about 8% to about 12%. More specifically, the suitable extensions of the grid 36 include a height to diameter ratio of about 9% to about 10%. In a particular example, the suitable extensions of the grid 36 is a height to diameter ratio of about 10%.

To continue with the description of FIG. 3, the applicator 10 further includes a forming cup 42. As shown in FIG. 3, the forming cup 42 is configured to form a seal with the retainer 32 at an interface 44 that is disposed between a lower edge of the retainer 32, relative to an orientation of FIG. 3, and an upper edge of the forming cup 42. The forming cup 42 includes an inner surface 46 configured to provide a molding surface for molding the shape of the substance 30. In this regard, the inner surface 46 may be sufficiently smooth to facilitate release of the substance 30. The inner surface 46 may also include a suitable release agent. Examples of suitable release agents include silicones, waxes, oils, and the like. A particular example of a suitable release agent includes a silicone-based release agent OPTISLIP™ (formerly CRODAMIDE™ E) manufactured by Cargill Inc. of Minneapolis, MN, 55440 USA. The forming cup 42 is also configured to provide a barrier between the substance 30 and exposure to air during storage.

FIG. 4 is an orthogonal view of a molding assembly 60 having the retainer 32, the forming cup 40, and the cover 16 for the applicator 10 of FIG. 1. As shown in FIG. 4, and with reference to FIG. 3, the molding assembly 60 includes the forming cup 40 nested into the cover 16 and the retainer 32 is coupled to the cover 16 to seal the interface 44. The extended portion or concavity of the grid 36 is disposed down into the forming cup 40 so that, in response to the substance 30 being poured into the molding assembly 60 while the substance 30 is in liquid form, the grid 36 can be covered and, eventually, encased in the substance 30 in response to the solidification of the substance 30. The seal at the interface 44 is configured to prevent or reduce leakage of the substance 30.

FIG. 5 is detail of the snap-lock 40 fastener to connect the retainer 32 to the adapter 20 for the applicator 10 of FIG. 1. As shown in FIG. 5, the snap-lock 40 includes an inclined plane 70 configured to facilitate urging a lip 72 of the adapter 20 outward as the retainer 32 is pressed into the adapter 20. In a well understood manner, once the inclined plane 70 is pressed past the lip 72, the lip 72 snaps back into place and the adapter 20 is fastened to the retainer 32. As already described, the adapter 20 and the retainer 36 may be any suitable shape. In examples in which the adapter 20 and retainer 36 are circular, the inclined plane 70 may include the shape of a frustum of a cone.

To reduce or prevent the retainer 32 rotating relative to the adapter 20, the snap-lock 40 may include one or more teeth or other such structures that mesh and resist rotation. In a particular example, the snap-lock 40 includes a plurality of teeth 74 disposed within the adapter 20 and a corresponding set of detents 74 disposed about the inclined plane 70 of the retainer 32. In response to the retainer 32 being pressed into the adapter 20 sufficiently to fasten the snap-lock 40, the teeth 74 and detents 74 are driven into a meshed engagement.

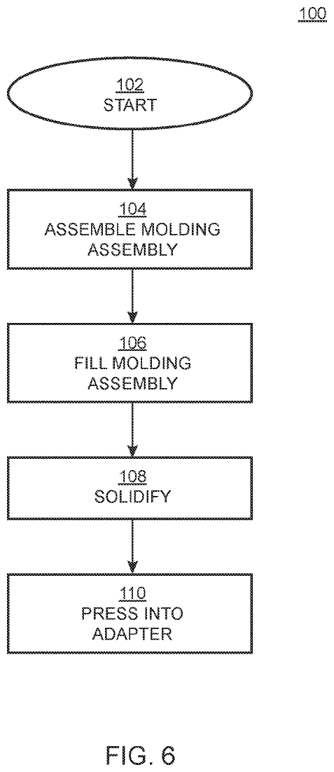

FIG. 6 is a flow diagram of a method 100 for manufacturing the applicator 10 of FIG. 1. Prior to starting the method 100 at step 102, various formulations of the substance 30 may be tested. As described herein, the applicator 10 is suitable for use with any solid or semi-solid medicament for application on a patient. In a particular example, the substance 30 may include a muscle-soothing ointment. In some embodiment, the substance 30 is molded into a desired shape, such as, for example, a hemisphere. In certain embodiments, the forming cup is hemispherical, and the molded medicament is formed into a corresponding hemisphere. It is an advantage of the applicator 10 that while the substance 30 is being applied, it may also act as a massaging device. Substance 30 may be a formulation containing one or more active pharmaceutical ingredient. A variety of active pharmaceutical ingredients may be used. In certain embodiment, the pharmaceutical ingredient includes one or more of menthol, camphor, capsaicin, fexofenadine, diphenhydramine, methyl salicylate, lidocaine, and hydrocortisone. In certain embodiments, formulations for the substance 30 may include menthol 1-16% (w/w), camphor 3-11% (w/w), a plurality of waxes 62-95.5% (w/w), a plasticizing agent 0.1-10% (w/w), and one or more optional essential oils 0-2% (w/w). More particular examples of formulations for the substance 30 are described in Table 1 below. Other suitable formulations are disclosed in PCT Application No. ______, filed ______, entitled “Massaging Balm Formulation” (Attorney Docket No. 070589.12792 (188WO2)), the disclosure of which is incorporated in its entirety as it pertains to formulations.

TABLE 1

| Component | Amount (w/w) | Amount (w/w) | Amount (w/w) |
|---|---|---|---|
| menthol | from about 1% to | from about 2% to | from about 3% to |
| | about 16% | about 14% | about 12% |
| camphor | from about 3% to | from about 4% to | from about 8% to |
| | about 11% | about 9% | about 14% |
| sweet almond (Prunus | from about 1% to | from about 22% to | from about 24% to |
| Amygdalus Dulcis) oil | about 30% | about 28% | about 27% |
| sunflower (helianthus | from about 1% to | from about 12% to | from about 13% to |
| annuus) seed wax | about 30% | about 16% | about 15% |
| cocoa (Theobroma | from about 1% to | from about 9% to | from about 10% to |
| cacao) seed butter | about 30% | about 15% | about 14% |
| coconut oil (Cocos | from about 1% to | from about 8% to | from about 10% to |
| nucifera) | about 30% | about 14% | about 13% |
| avocado (Persea | from about 1% to | from about 1% to | from about 2% to |
| gratissima) oil | about 30% | about 5% | about 4% |
| avocado (Persea | from about 1% to | from about 3% to | from about 3% to |
| gratissima) butter | about 30% | about 12% | about 10% |
| carnauba (Copernica | from about 1% to | from about 1% to | from about 2% to |
| cerifera) wax | about 30% | about 9% | about 8% |
| plasticizer | from about 0.1% | from about 0.5% | from about 0.75% |
| | to about 10% | to about 8% | to about 2% |
| eucalyptus (Eucalyptus | from about 0.01% | from about 0.05% | from about 0.05% |
| globulus) oil | to about 1% | to about 0.9% | to about 0.8% |
| grapefruit (Citrus | from about 0.01% | from about 0.05% | from about 0.05% |
| paradisi) peel oil | to about 1% | to about 0.9% | to about 0.8% |
| peppermint (Mentha | from about 0.01% | from about 0.05% | from about 0.05% |
| piperita) oil | to about 1% | to about 0.9% | to about 0.8% |
| spearmint (Mentha | from about 0.01% | from about 0.05% | from about 0.05% |
| viridis) oil | to about 1% | to about 0.9% | to about 0.8% |

Of particular note, the concentration of plasticizer may be modulated in conjunction with the shape and conformation of the grid 36 shown in FIGS. 3 and 4. For example, adjusting the concentration of the plasticizer may facilitate a reduction or other adjustment in a degree to which the grid 36 extends into or out from the forming cup 42 and/or a change in the arrangement of the grid 36. Of note, the various formulations of the substance 30 may include any suitable plasticizer such as, a polymer, a natural and/or synthetic wax, a resin, or the like.

To continue with the description of the method 100. At step 102 the method begins with acquiring the various components of the applicator 10 and preparing the substance 30 in liquid or semi-liquid form.

At step 104, the molding assembly 60 is assembled by nesting the forming cup 42 into the cover 16. The retainer 32 is disposed upon the nested components and then coupled by engaging the clasp 34. For example, the retainer 32 can be rotated relative to the cover 16 until the clasp 34 is fastened. In this manner, the molding assembly 60 is assembled and a seal if formed at the interface 44.

At step 106, the molding assembly 60 is filled with the liquid or semi-liquid substance 30. For example, the substance 30 may be supplied in a heated form to liquify the substance 30. A fill tube may supply the heated substance 30 at a rate that is sufficiently slow so as not to splash or introduce excessive aeration.

At step 108, the substance 30 is cooled or otherwise allowed to solidify. Following or during solidification of the substance 30, the filled molding assembly 60 may be pressed onto the adapter 20 of the handle unit 14. As described herein, the snap-lock 40 may be fastened in response to the retainer 32 being sufficiently pressed into the adapter 20.

Thereafter, the applicator 10 may be packaged, stored, transported, and sold for use by users or patients. In use, the handle 18 may be grasped with one hand and the cover 16 removed, by twisting for example, by the other hand. The forming cup 42 may be removed and returned to the cover 16 or discarded. Thereafter, the applicator 10 is ready for use. The cover 16 may be re-attached to the handle unit 14 when not in use.

### EMBODIMENTS

Provided here are number embodiments of the disclosed technology. These embodiments are illustrative only and do not limit the scope of the present disclosure or of the claims attached.
Embodiment 1. An applicator comprising:
a housing, the housing includes:
a handle unit, the handle unit including a handle and an adapter; and
a cover, the cover including a clasp to releasably secure the adapter to the cover;
a retainer configured to secure a substance thereto, the retainer including a fastener disposed on a first rim of the retainer, the fastener to secure the first rim of the retainer to the adapter.
Embodiment 2. The applicator according to embodiment 1, further comprising a forming cup having an inner surface configured to provide a mold for forming the substance.
Embodiment 3. The applicator according to any preceding embodiment, wherein the applicator is configured to facilitate massaging the substance onto a skin of a subject.
Embodiment 4. The applicator according to any preceding embodiment, wherein a rim of the forming cup is configured to form a seal with a second rim of the retainer.
Embodiment 5. The applicator according to any preceding embodiment, wherein the forming cup is configured to nest within the cover.
Embodiment 6. The applicator according to any preceding embodiment, wherein the clasp is disposed on an outer portion of the second rim of the retainer.
Embodiment 7. The applicator according to any preceding embodiment, further comprising a grid disposed in the retainer, wherein the grid is molded into the substance in response to solidification of a liquid form of the substance filling the forming cup and covering at least a portion of the grid.
Embodiment 8. The applicator according to any preceding embodiment, wherein the grid includes a portion that extends into or out from the forming cup in response to the forming cup being sealed to the second rim of the retainer.
Embodiment 9. The applicator according to any preceding embodiment, wherein a portion of the grid extending into or out of the forming cup at a ratio in a range of 5% to 15% of a diameter of the retainer.
Embodiment 10. The applicator according to any preceding embodiment, wherein the extension of the grid extends into the forming cup at a ratio in a range of 8% to 12% of the diameter of the retainer.
Embodiment 11. The applicator according to any preceding embodiment, wherein the first rim of the retainer is defined by a frustum of a cone configured to facilitate elastic deformation of an engaging member in the adapter and a snap-lock engagement that defines the fastener.
Embodiment 12. The applicator according to any preceding embodiment, wherein the first rim of the retainer includes a plurality of teeth, and the adapter includes a corresponding plurality of teeth to mesh with the plurality of teeth of the first rim of the retainer.
Embodiment 13. The applicator according to any preceding embodiment, further comprising a release agent disposed on the inner surface of the forming cup to facilitate the substance being released from the forming cup.
Embodiment 14. An applicator according to any one of embodiments 1 to 13, wherein a substance is attached to the retainer.
Embodiment 15. The applicator according to embodiment 14, wherein the substance is in a hemispherical shape.
Embodiment 16. The applicator according to embodiments 13 or 14, wherein the substance is configured to be secured in the retainer.
Embodiment 17. The applicator according to embodiments 13 or 14, wherein the substance comprises a medicament, a lotion, or a cream.
Embodiment 18. The applicator according to embodiment 17, wherein the substance comprises a medicament.
Embodiment 19. The applicator according to embodiment 18, wherein the medicament comprises one or more of menthol, camphor, lidocaine, methyl salicylate, capsaicin, hydrocortisone, diphenhydramine, or fexofenadine.
Embodiment 20. The applicator according to embodiment 19, wherein the medicament comprises menthol and camphor.
Embodiment 21. The applicator according to embodiment 20, wherein the medicament comprises: menthol; camphor; and a plurality of waxes and oils configured to secure the substance in the retainer.
Embodiment 22. A method of making the applicator according to any one of embodiments 14 to 21, the method comprising:
assembling a mold assembly by nesting the forming cup into the cover and securing the retainer to the cover with the clasp;
filling the mold assembly with the substance in liquid form so that the substance covers the grid of the retainer;
solidifying the substance; and
pressing the filled mold assembly into the adapter to urge the fastener to fasten.
Embodiment 23. The method according to embodiment 22 wherein the forming cup is hemispherical, and the molded substance is formed into a corresponding hemisphere.
Embodiment 24. The method according to embodiment 22 wherein the applicator is configured to facilitate messaging the molded substance onto a skin of a subject.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An applicator comprising:
a housing, the housing includes:
a handle unit, the handle unit including a handle and an adapter; and
a cover, the cover including a clasp to releasably secure the adapter to the cover; and
a retainer configured to secure a substance thereto, the retainer including a fastener disposed on a first rim of the retainer, the fastener to secure the first rim of the retainer to the adapter.

2. The applicator according to claim 1, further comprising a forming cup having an inner surface configured to provide a mold for forming a substance.

3. The applicator according to claim 2, wherein the applicator is configured to facilitate massaging the substance onto a skin of a subject.

4. The applicator according to claim 2, wherein a rim of the forming cup is configured to form a seal with a second rim of the retainer.

5. The applicator according to claim 2, wherein the forming cup is configured to nest within the cover.

6. The applicator according to claim 4, wherein the clasp is disposed on an outer portion of the second rim of the retainer.

7. The applicator according to claim 4, further comprising a grid disposed in the retainer, wherein the grid is molded into the substance in response to solidification of a liquid form of the substance filling the forming cup and covering at least a portion of the grid.

8. The applicator according to claim 7, wherein the grid includes a portion that extends into or out from the forming cup in response to the forming cup being sealed to the second rim of the retainer.

9. The applicator according to claim 7, wherein the portion of the grid extends into or out from the forming cup at a ratio in a range of 5% to 15% of a diameter of the retainer.

10. The applicator according to claim 9, wherein the portion of the grid extends into or out from the forming cup at a ratio in a range of 8% to 12% of the diameter of the retainer.

11. The applicator according to claim 1, wherein the first rim of the retainer is defined by a frustum of a cone configured to facilitate elastic deformation of an engaging member in the adapter and a snap-lock engagement that defines the fastener.

12. The applicator according to claim 1, wherein the first rim of the retainer includes a plurality of teeth, and the adapter includes a corresponding plurality of teeth to mesh with the plurality of teeth of the first rim of the retainer.

13. The applicator according to claim 2, further comprising a release agent disposed on the inner surface of the forming cup to facilitate the substance being released from the forming cup.

14. An applicator according to claim 1, wherein a substance is attached to the retainer.

15. The applicator according to claim 14, wherein the substance is in a hemispherical shape.

16. The applicator according to claim 13, wherein the substance is configured to be secured in the retainer.

17. The applicator according to claim 13, wherein the substance comprises a medicament, a lotion, or a cream.

18. The applicator according to claim 17, wherein the substance comprises a medicament.

19. The applicator according to claim 18, wherein the medicament comprises one or more of menthol, camphor, lidocaine, methyl salicylate, capsaicin, hydrocortisone, diphenhydramine, or fexofenadine.

20. The applicator according to claim 19, wherein the medicament comprises menthol and camphor.

21. The applicator according to claim 20, wherein the medicament comprises:
menthol;
camphor; and
a plurality of waxes and oils configured to secure the substance in the retainer.

22. A method of making the applicator according to claim 14, the method comprising:
assembling a mold assembly by nesting the forming cup into the cover and securing the retainer to the cover with the clasp;
filling the mold assembly with the substance in liquid form so that the substance covers a grid disposed in the retainer;
solidifying the substance; and
pressing the filled mold assembly into the adapter to urge the fastener to fasten.

23. The method according to claim 22 wherein the forming cup is hemispherical, and the substance is formed into a corresponding hemisphere.

24. The method according to claim 22 wherein the applicator is configured to facilitate messaging the molded substance onto a skin of a subject.
